(19) United States
(12) Patent Application Publication
(10) Pub. No.: US 2007/0077505 A1
(43) Pub. Date: Apr. 5, 2007

(54) Imaging member

(75) Inventors: Liang-bih Lin, Rochester, NY (US); Daniel V. Levy, Rochester, NY (US); Jin Wu, Webster, NY (US); Marc J. Livecchi, Rochester, NY (US); Francisco Lopez, Rochester, NY (US)

Correspondence Address: PILLSBURY WINTHROP SHAW PITTMAN LLP, P.O BOX 10500, McLean, VA, 22102, US

(73) Assignee: Xerox Corporation, Stamford, CT (US)

(21) Appl. No.: 11/243,410

(22) Filed: Oct. 4, 2005

(51) Int. Cl. G03G 5/047; G03G 5/14

(52) U.S. Cl. 430/58.25; 430/60; 430/58.5; 430/131

(57) ABSTRACT

The presently disclosed embodiments relate in general to electrophotographic imaging members, such as layered photoreceptor structures, and processes for making and using the same. More particularly, the embodiments pertain to a photoreceptor that incorporates electron transport additives in an imaging layer to improve background and print image quality.

### BACKGROUND

Herein disclosed are imaging members, such as layered photoreceptor structures, and processes for making and using the same. The imaging members can be used in electrophotographic, electrostatographic, xerographic and like devices, including printers, copiers, scanners, facsimilies, and including digital, image-on-image, and like devices. More particularly, the embodiments pertain to a photoreceptor that incorporates specific molecules to facilitate electron transport across the layers of the photoreceptor device.

Electrophotographic imaging members, e.g., photoreceptors, typically include a photoconductive layer formed on an electrically conductive substrate. The photoconductive layer is an insulator in the substantial absence of light so that electric charges are retained on its surface. Upon exposure to light, charge is generated by the photoactive pigment, and under applied field charge moves through the photoreceptor and the charge is dissipated.

In electrophotography, also known as xerography, electrophotographic imaging or electrostatographic imaging, the surface of an electrophotographic plate, drum, belt or the like (imaging member or photoreceptor) containing a photoconductive insulating layer on a conductive layer is first uniformly electrostatically charged. The imaging member is then exposed to a pattern of activating electromagnetic radiation, such as light. Charge generated by the photoactive pigment move under the force of the applied field. The movement of the charge through the photoreceptor selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

An electrophotographic imaging member may be provided in a number of forms. For example, the imaging member may be a homogeneous layer of a single material such as vitreous selenium or it may be a composite layer containing a photoconductor and another material. In addition, the imaging member may be layered. These layers can be in any order, and sometimes can be combined in a single or mixed layer.

Typical multilayered photoreceptors have at least two layers, and may include a substrate, a conductive layer, an optional charge blocking layer, an optional adhesive layer, a photogenerating layer (sometimes referred to as a “charge generation layer,” “charge generating layer,” or “charge generator layer”), a charge transport layer, an optional overcoating layer and, in some belt embodiments, an anticurl backing layer. In the multilayer configuration, the active layers of the photoreceptor are the charge generation layer (CGL) and the charge transport layer (CTL). Enhancement of charge transport across these layers provide better photoreceptor performance.

The demand for improved print quality in xerographic reproduction is increasing, especially with the advent of color. Common print quality issues are strongly dependent on the quality of the undercoat layer. Conventional materials used for the undercoat or blocking layer have been problematic. In certain situations, a thicker undercoat is desirable, but the thickness of the material used for the undercoat layer is limited by the inefficient transport of the photo-injected electrons from the generator layer to the substrate. If the undercoat layer is too thin, then incomplete coverage of the substrate results due to wetting problems on localized unclean substrate surface areas. The incomplete coverage produces pin holes which can, in turn, produce print defects such as charge deficient spots (“CDS”) and bias charge roll (“BCR”) leakage breakdown. Other problems include “ghosting,” which is thought to result from the accumulation of charge somewhere in the photoreceptor. Consequently, when a sequential image is printed, the accumulated charge results in image density changes in the current printed image that reveals the previously printed image. Thus, there is a need, which is addressed herein, for a way to minimize or eliminate charge accumulation in photoreceptors, without sacrificing the desired thickness of the undercoat layer.

The terms “charge blocking layer” and “blocking layer” are generally used interchangeably with the phrase “undercoat layer.”

Conventional photoreceptors and their materials are disclosed in Katayama et al., U.S. Pat. No. 5,489,496; Yashiki, U.S. Pat. No. 4,579,801; Yashiki, U.S. Pat. No. 4,518,669; Seki et al., U.S. Pat. No. 4,775,605; Kawahara, U.S. Pat. No. 5,656,407; Markovics et al., U.S. Pat. No. 5,641,599; Monbaliu et al., U.S. Pat. No. 5,344,734; Terrell et al., U.S. Pat. No. 5,721,080; and Yoshihara, U.S. Pat. No. 5,017,449, which are herein incorporated by reference in their entirety.

More recent photoreceptors are disclosed in Fuller et al., U.S. Pat. No. 6,200,716; Maty et al., U.S. Pat. No. 6,180,309; and Dinh et al., U.S. Pat. No. 6,207,334, which are herein incorporate by reference in their entirety.

### SUMMARY

According to embodiments illustrated herein, there is provided a way in: which print quality is improved, for example, ghosting is minimized or substantially eliminated in images printed in systems with high transfer current.

In one embodiment, there is provided an electrophotographic imaging member, comprising a substrate, an undercoat layer formed on the substrate, wherein the undercoat layer comprises a metal oxide, and a charge transport layer, the charge transport layer further comprising an electron transport additive selected from the group consisting of—a carboxlfluorenone malonitrile (CFM) derivative represented by: 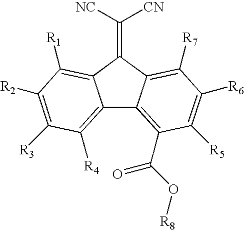
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a nitrated fluoreneone derivative represented by: 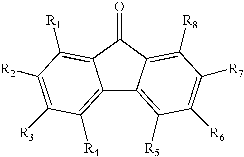
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups; a N,N′bis(dialkyl)-1,4,5,8-naphthalenetetracarboxylic diimide derivative represented by: 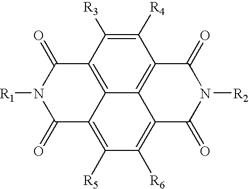
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different; a N,N′bis(diaryl)-1,4,5,8-naphthalenetetracarboxylic diimide derivative represented by: 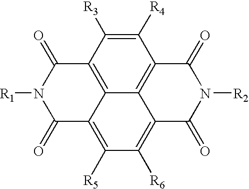
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different; a 1,1′-dioxo-2-(aryl)-6-phenyl-4-(dicyanomethylidene)thiopyran derivative represented by: 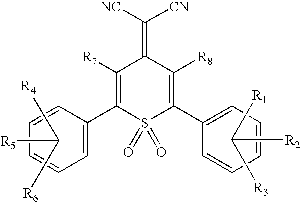
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a carboxybenzylnaphthaquinone derivative represented by: 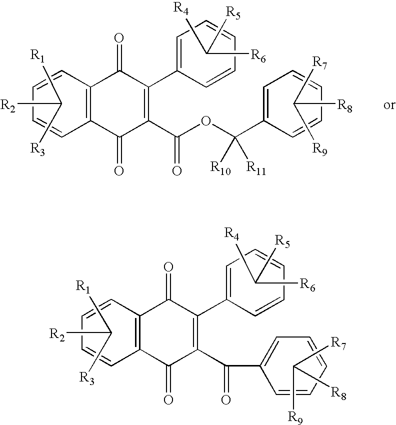
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a diphehoquinone represented by: 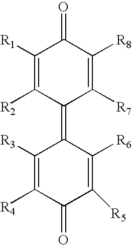
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; and mixtures thereof.

In an alternative embodiment, there is disclosed a process for preparing an electrophotographic imaging member, comprising applying a first coating on a substrate, the first coating having a metal oxide, and applying a second coating over the first coating, the second coating having an electron transport additive selected from the group consisting of—a carboxlfluorenone malonitrile (CFM) derivative represented by: 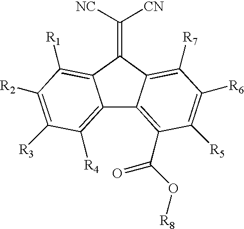
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a nitrated fluoreneone derivative represented by: 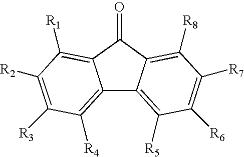
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups; a N,N′bis(dialkyl)-1,4,5,8-naphthalenetetracarboxylic diimide derivative represented by: 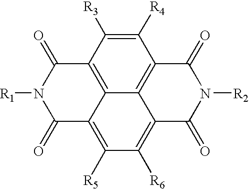
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different; a N,N′bis(diaryl)-1,4,5,8-naphthalenetetracarboxylic diimide derivative represented by: 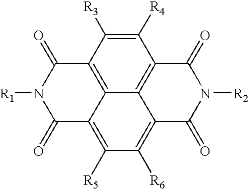
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different; a 1,1′-dioxo-2-(aryl)-6-phenyl-4-(dicyanomethylidene)thiopyran derivative represented by: 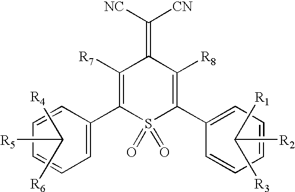
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a carboxybenzylnaphthaquinone derivative represented by: 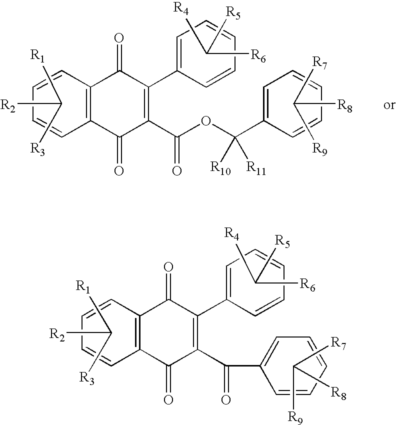
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a diphenoquinone represented by: 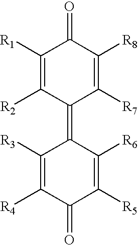
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; and mixtures thereof.

### DETAILED DESCRIPTION

It is understood that other embodiments may be utilized and structural and operational changes may be made without departure from the scope of the embodiments disclosed herein.

The embodiments relate to a photoreceptor having a undercoat layer which incorporates an additive to the formulation that helps reduce, and preferably substantially eliminates, specific printing defects in the print images.

According to embodiments herein, an electrophotographic imaging member is provided, which generally comprises at least a substrate layer, an undercoat layer, and an imaging layer. The undercoating layer is generally located between the substrate and the imaging layer, although additional layers may be present and located between these layers. The imaging member may also include a charge generating layer and a charge transport layer. The imaging member can be employed in the imaging process of electrophotography, where the surface of an electrophotographic plate, drum, belt or the like (imaging member or photoreceptor) containing a photoconductive insulating layer on a conductive layer is first uniformly electro statically charged. The imaging member is then exposed to a pattern of activating electromagnetic radiation, such as light. The radiation selectively dissipates the charge on the illuminated areas of the photoconductive insulating layer while leaving behind an electrostatic latent image. This electrostatic latent image may then be developed to form a visible image by depositing oppositely charged particles on the surface of the photoconductive insulating layer. The resulting visible image may then be transferred from the imaging member directly or indirectly (such as by a transfer or other member) to a print substrate, such as transparency or paper. The imaging process may be repeated many times with reusable imaging members.

Thick undercoat layers are desirable for photoreceptors due to their life extension and carbon fiber resistance. Furthermore, thicker undercoat layers make it possible to use less costly substrates in the photoreceptors. Such thick undercoat layers have been developed, such as one developed by Xerox Corporation and disclosed in U.S. patent application Ser. No. 10/942,277, filed Sep. 16, 2004, entitled “Photoconductive Imaging Members,” which is hereby incorporated by reference in its entirety. However, due to insufficient electron conductivity in dry and cold environments, the residual potential in conditions known as “J zone” (low RH, 5% at a temperature of 70° F.) is unacceptably high (e.g., >150V) when the undercoat layer is thicker than 15 μm.

Common print quality issues are strongly dependent on the quality of the undercoat layer. Conventional materials used for the undercoat or blocking layer have been problematic because print quality issues are strongly dependent on the quality of the undercoat layer. For example, charge deficient spots (“CDS”) and bias charge roll (“BCR”) leakage breakdown are problems the commonly occur. Another problem is “ghosting,” which is thought to result from the accumulation of charge somewhere in the photoreceptor. Consequently, when a sequential image is printed, the accumulated charge results in image density changes in the current printed image that reveals the previously printed image.

There have been formulations developed for undercoat layers that, while suitable for their intended purpose, do not address the ghosting effect problem. In certain electrophotographic apparatuses, especially those used for graphic art, involve substantially higher transfer current setups, e.g. 40 μA, than more traditional setups. To alleviate the problems associated with charge block layer thickness and high transfer currents, the addition of charge transfer molecules, such as metal oxides, to undercoat formulations is performed to produce a charge transfer complex that helps reduce and preferably substantially eliminate ghosting failure in xerographic reproductions. One such charge transfer molecule is disclosed in commonly assigned U.S. patent application Ser. No. 11/213,522, filed Aug. 26, 2005, entitled “Photoreceptor Additive,” which is hereby incorporated by reference in its entirety.

According to embodiments, the ghosting level is even further reduced in xerographic reproductions. In embodiments, specific electron transport additives are added to the charge transport layer in an imaging member that also includes an undercoat layer containing a metal oxide, such as TiO₂. The combination has demonstrated to substantially reduce ghosting levels to a grade not yet achieved in xerographic reproduction with other types of imaging members.

Typical electron transport additives that can be used with embodiments disclosed herein include, but are not limited to, N,N′bis(1,2-dimethylpropyl)-1,4,5,8-naphthalenetetracarboxylic diimide (NTDI), n-butoxycarbonyl-9-fluorenylidene malonitrile (BCFM), and 2-ethylhexylbutoxycarbonyl-9-fluorenylidene malonitrile (EHCFM).

In alternative embodiments, the additives may further be one or more of the following—a carboxlfluorenone malonitrile (CFM) derivative represented by: 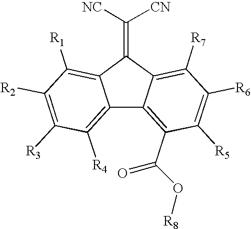
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a nitrated fluoreneone derivative represented by: 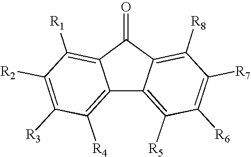
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups; a N,N′bis(dialkyl)-1,4,5,8-naphthalenetetracarboxylic diimide derivative represented by: 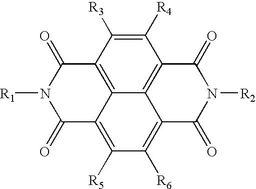
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50 or between 1 and 12, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different, and in the case were R3, R4, R5 and R6 are carbon, they can be chosen independently to have a total carbon number between 1 and 50 or between 1 and 12; a N,N′bis(diaryl)-1,4,5,8-naphthalenetetracarboxylic diimide derivative represented by: 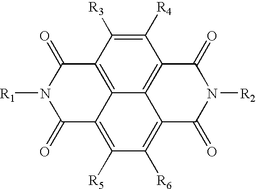
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50 or between 1 and 12, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different, and in the case were R3, R4, R5 and R6 are carbon, they can be chosen independently to have a total carbon number between 1 and 50 or between 1 and 12; a 1,1′-dioxo-2-(aryl)-6-phenyl-4-(dicyanomethylidene)thiopyran derivative represented by: 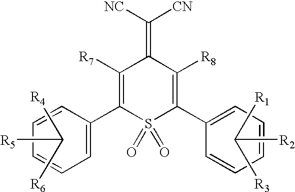
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a carboxybenzylnaphthaquinone derivative represented by: 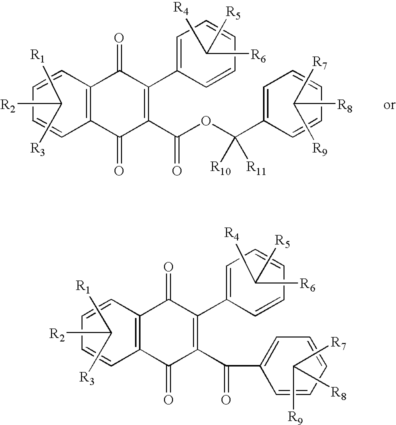
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; a diphenoquinone represented by: 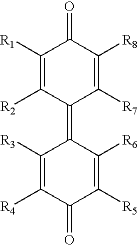
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen; and mixtures thereof. The additive may also comprise oligomeric and polymeric derivatives of which the above moieties represent part of the oligomer or polymer repeat units.

In embodiments, the metal oxide can be selected from, for example, the group consisting of ZnO, SnO₂, TiO₂, Al₂O₃, SiO₂, ZrO₂, In₂O₃, MoO₃, and a mixture thereof. In various embodiments, the metal oxide can be TiO₂. In various embodiments, TiO₂ can be either surface treated or untreated. Surface treatments include, but are not limited to aluminum laurate, alumina, zirconia, silica, silane, methicone, dimethicone, sodium metaphosphate, and the like and mixtures thereof. Examples of TiO₂ include MT-150W (surface treatment with sodium metaphosphate, Tayca Corporation), STR-60N (no surface treatment, Sakai Chemical Industry Co., Ltd.), FTL-100 (no surface treatment, Ishihara Sangyo Laisha, Ltd.), STR-60 (surface treatment with Al203, Sakai Chemical Industry Co., Ltd.), TTO-55N (no surface treatment, Ishihara Sangyo Laisha, Ltd.), TTO-55A (surface treatment with Al203, Ishihara Sangyo Laisha, Ltd.), MT-150AW (no surface treatment, Tayca Corporation), MT-150A (no surface treatment, Tayca Corporation), MT-100S (surface treatment with aluminum laurate and alumina, Tayca Corporation), MT-100HD (surface treatment with zirconia and alumina, Tayca Corporation), MT-100SA (surface treatment with silica and alumina, Tayca Corporation), and the like. The metal oxide is incorporated into the undercoat layer formulation.

In various embodiments, the undercoat layer has a thickness of from about 0.1 μm to about 30 μm, or from about 2 μm to about 25μm, or from about 10μm to about 20 μm. The metal oxide may be present in an amount of from about 5 percent to about 90 percent by weight of the total weight of the undercoat layer.

Embodiments of the imaging member have thickness of the charge transport layer from about 5 μm to about 40 μm. The electron transport additive may be present in an amount of from about 0.05 percent to about 10 percent by weight of the total weight of the charge transport layer.

In embodiments, the specific electron transport additive is physically impregnated into the charge transport layer formulation by physically mixing it into the dispersed formulation. Physically “doping” the molecules into the charge transport layer prevents low mobility holes from accumulating at the interface between the charge generating and charge transporting layer. Some methods that can be used to incorporate an additive into a formulation to form a charge transport layer include the following: (1) simple mixing of an electron transport additive, with a charge transport layer formulation, with the formulation being previously dispersed before adding the molecule (2) ball milling an electron transport additive with the charge transport layer formulation. In particular embodiments, where the metal oxide is TiO₂, the TiO₂ may have a powder volume resistivity of from about 1×10⁴ to about 1×10¹⁰ Ωcm under a 100 kg/cm² loading pressure at 50% humidity and at room temperature.

After forming the coating mixtures for the undercoat layer and the charge generating layer, each is applied to the imaging member substrate. The coating mixture having the metal oxide is applied onto the substrate to form an undercoat layer. In one embodiment, the coating mixture having the electron transport additive is applied onto the undercoat layer to form an imaging layer, specifically, a charge generating layer.

The undercoat layer and charge transport layer may be applied or coated onto a substrate by any suitable technique known in the art, such as spraying, dip coating, draw bar coating, gravure coating, silk screening, air knife coating, reverse roll coating, vacuum deposition, chemical treatment and the like. Additional vacuuming, heating, drying and the like, may be used to remove any solvent remaining after the application or coating to form the undercoat layer or the charge transport layer.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the embodiments herein. All proportions are by weight unless otherwise indicated. It will be apparent, however, that the embodiments can be practiced with many types of compositions and can have many different uses in accordance with the disclosure above and as pointed out hereinafter.

### Example I

There is provided an imaging member with substantially high transfer current (˜40 μA). The imaging member exhibits severe negative ghosting that is G6+ in all testing zones (A, B, and J), which is much higher than normal specifications of G4. The imaging member is comprised of an undercoating layer, comprising a silane, Zr(acac)₂, and polyvinyl butyral, a charge generation layer, comprising chlorogallium phthalocyanine and vinyl chloride/vinyl acetate co-polymer, and a charge transporting layer, comprising polytetrafluoroethylene (PTFE) microparticles, a polycarbonate, and an arylamine charge transport additive. By replacing the undercoat layer with a titanium oxide based undercoat layer, comprising titanium oxide (MT-150W from Tayca Corp), a melamine binder (Cymel 323 from Cytec), and a phenolic resin (Varcum from Oxychem), the ghosting in A and B zones are substantially reduced to G1 but the J Zone ghosting is still at G4-5. Attempts to optimize the undercoat formulations through material solutions such as doping chelating electron acceptors and processing conditions modification such as drying time and temperature had only generated marginal improvement with at most 0.5 grade reduction in J zone negative ghosting. Having a high conduction and less humidity sensitive undercoat layer, such as the above formulation, is certainly essential in reducing ghosting, showing excellent results in A and B zones, which suggests that fewer electrons are being trapped at the charge generation layer and undercoat layer. However, in J zone conditions such ghosting reduction is limited, indicating that there are still some unwanted electrons at the interface or that some trapped holes are still present in J zone that cannot be affected by any undercoat layers. Research on charge transport properties of binary composite of electron and hole transport additives has revealed a unique phenomenon of certain electron transport additives enhancing the hole transport mobility of hole transport additive (Lin, L. B., Jenekhe, S. A., Borsenberger, P. M., Applied Physics Letters, 69 (23): 3495-3497 (1996)).

### Example II

Embodiments involve impregnating or doping electron transport additives into the charge transport layer. The molecules can improve hole injection from the charge generation layer into the charge transport layer, especially at low electric fields, the condition that most leads to ghosting.

Several electron transport additives were tested, including N,N′bis(1,2-dimethylpropyl)-1,4,5,8-naphthalenetetracarboxylic diimide (NTDI), n-butoxycarbonyl-9-fluorenylidene malonitrile (BCFM), and 2-ethylhexylbutoxycarbonyl-9-fluorenylidene malonitrile (EHCFM). Among them, the latter two showed best results in J Zone conditions by reducing ghosting by at least two grades. Physical doping of the electron transport additives was done adding 2.5-5% with respect to the total solid weight of other charge transport components, PTFE particles, N,N′-diphenyl-N,N′-bis(methylphenyl)-1,1-biphenyl-4,4′-diamine, and polycarbonate. And the examples given here were by doping the electron transport additives to a prepared dispersion of the other charge transport components. The electron transport additives may also be incorporated during the dispersion preparation.

The basic configuration of the experimental devices is a 404 mm×30 mm aluminum alloy pipe with, in order of coating sequence, a 5 μm TUC Type 8 undercoating layer, comprising MT-150W TiO₂/Phenolic Resin/Cymel 323 at a weight ratio of 63/26/11, a charge generation layer, comprising chlorogallium phthalocyanine and vinylchloride/Vinyl acetate co-polymer at a weight ratio of 54/46, and a electron transport additives-doped PTFE charge transporting layer of about 29 μm. The print test results are shown in Table 1. Nominal electrical properties were observed with any electron transport additives-doped devices with doping weight percentage at a high of 5%. Representative photoinduced discharge characteristics (PIDC) curves of the experimental device with 0% electron transport additives, 2.5% BCFM, 5% BCFM, and 5% EHCFM doped PTFE charge transport layer including a 5 μm thick undercoat layer Type 8 and a chlorogallium phthalocyanine charge generation layer are shown in FIG. 1. The PIDC curves show that all electron transport additive-doped devices have normal photoelectrical properties. Print testing was done in J zone conditions on a Work centre Pro (WCP) 3545 using black and white copy mode. With as little as 2.5% electron transport additives of BCFM doping, ghosting is reduced from G4-5 to G2. The decrease in grade demonstrates a very significant signal in ghosting improvement.

TABLE 1
J Zone Ghosting Print Test Results (Copland engine).

| | ETM in CTL (all | | | | |
|---|---|---|---|---|---|
| | with a 5 μm | Machine | | Ghost | Ghost |
| Drum # | TUC8) | speed | Zone | T = 0 | T = 200 |
| 05126505 | 0% | 208 mm | J 70/10% | 1 | 5 |
| 05126506 | 2.5% BCFM | 208 mm | J 70/10% | 0 | 2 |
| 05126507 | 5% BCFM | 208 mm | J 70/10% | 1 | 2 |
| 05126508 | 5% EHCFM | 208 mm | J 70/10% | 0 | 2 |

Details of testing conditions are described as follows. Drums were acclimated for 24 hours before testing in J zone (70° F./10% RH). Print testing was conducted in WCP 3545 using black and white Copy mode to achieve a machine speed of 208 mm. Ghosting levels were measured against a visual ghosting (SIR) scale.

The printing protocol involved (1) printing ghost target at T=0; (2) printing 200 5% area coverage documents; (3) printing Ghost Target at T=200; and (4) printing visually analyze print comparing to a visual ghosting (SIR) scale. The test equipment used included a WCP 3545, Ghosting SIR, and Ghosting document, and 5% area coverage line and block document.

The above examples demonstrate a novel method of significant reduction of (J Zone) ghosting in high transfer current engines, such as WCP 3545, by doping a small quantity of electron transport additive into the charge transporting layer, in combination with a titanium oxide-based undercoat layer, which is used in ghosting reduction in all other zones.

What is claimed is:

1. An electrophotographic imaging member, comprising:
a substrate;
an undercoat layer formed on the substrate, wherein the undercoat layer comprises a metal oxide; and
an imaging layer formed on the undercoat layer, wherein the imaging layer is a charge transport layer comprising an electron transport additive selected from the group consisting of:
a) a carboxlfluorenone malonitrile (CFM) derivative represented by: 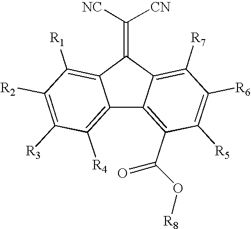
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
b) a nitrated fluoreneone derivative represented by: 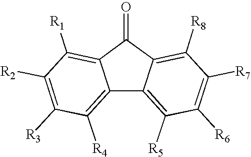
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups;
c) a N,N′bis(dialkyl)-1,4,5,8-naphthalenetetracarboxylic diimide derivative represented by: 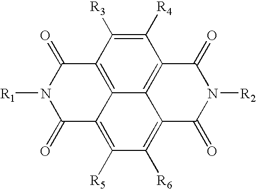
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different;
d) a N,N′bis(diaryl)-1,4,5,8-naphthalenetetracarboxylic diimide derivative represented by: 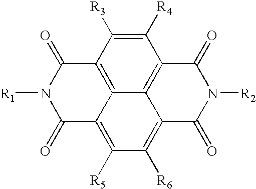
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different;
e) a 1,1′-dioxo-2-(aryl)-6-phenyl-4-(dicyanomethylidene)thiopyran derivative represented by: 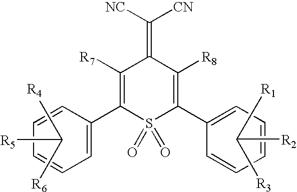
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
f) a carboxybenzylnaphthaquinone derivative represented by: 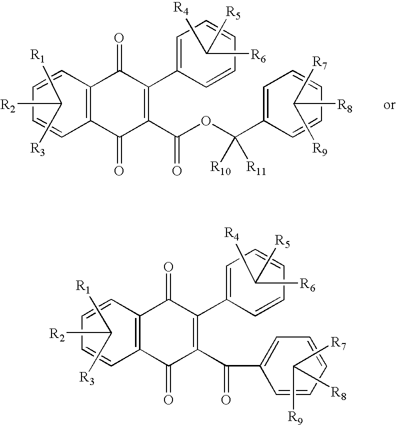
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
g) a diphenoquinone represented by: 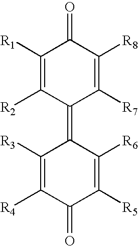
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
h) and mixtures thereof.

2. The electrophotographic imaging member of claim 1, wherein the imaging layer further includes a charge generating layer which is formed above or below the charge transport layer.

3. The electrophotographic imaging member of claim 1, wherein the metal oxide is selected from the group consisting of ZnO, SnO₂, Al₂O₃, SiO₂, ZrO₂, In₂O₃, MoO₃, TiO₂ and mixtures thereof.

4. The electrophotographic imaging member of claim 1, wherein the thickness of the undercoat layer is from about 0.2 microns to about 30 microns.

5. The electrophotographic imaging member of claim 1, wherein the thickness of the charge transport layer is from about 5 microns to about 40 microns.

6. The electrophotographic imaging member of claim 1, wherein the electron transport additive is present in an amount of from about 0.05 percent to about 10 percent by weight of the total weight of the charge transport layer.

7. An electrophotographic imaging member, comprising:
a substrate;
an undercoat layer formed on the substrate, wherein the undercoat layer comprises TiO₂; and
an imaging layer formed on the undercoat layer, wherein the imaging layer is a charge transport layer comprising an electron transport additive selected from the group consisting of:
a) a carboxlfluorenone malonitrile (CFM) derivative represented by: 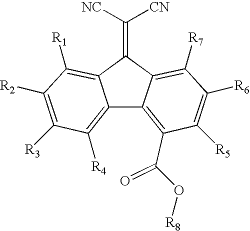
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
b) a nitrated fluoreneone derivative represented by: 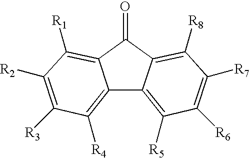
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups;
c) a N,N′bis(dialkyl)-1,4,5,8-naphthalenetetracarboxylic diimide derivative represented by: 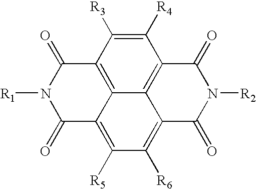
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different;
d) a N,N′bis(diaryl)-1,4,5,8-naphthalenetetracarboxylic diimide derivative represented by: 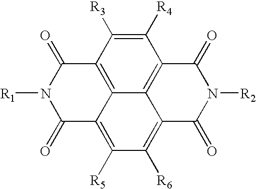
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different;
e) a 1,1′-dioxo-2-(aryl)-6-phenyl-4-(dicyanomethylidene)thiopyran derivative represented by: 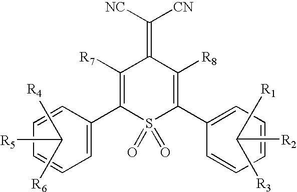
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
f) a carboxybenzylnaphthaquinone derivative represented by: 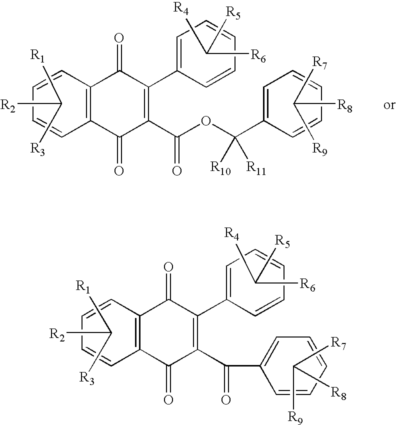
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
g) a diphenoquinone represented by: 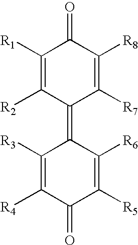
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
h) and mixtures thereof.

8. A process for preparing an electrophotographic imaging member, comprising:
applying a first coating on a substrate, the first coating having a metal oxide; and
applying a second coating over the first coating, the second coating having an electron transport additive selected from the group consisting of:
a) a carboxlfluorenone malonitrile (CFM) derivative represented by: 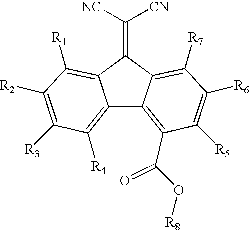
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
b) a nitrated fluoreneone derivative represented by: 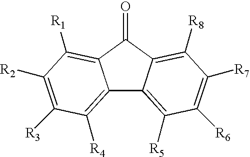
wherein each R is independently selected from the group consisting of hydrogen, alkyl having 1 to 40 carbon atoms, alkoxy having 1 to 40 carbon atoms, phenyl, substituted phenyl, higher aromatics such as naphthalene and anthracene, alkylphenyl having 6 to 40 carbons, alkoxyphenyl having 6 to 40 carbons, aryl having 6 to 30 carbons, substituted aryl having 6 to 30 carbons and halogen, and wherein at least two R groups are chosen to be nitro groups;
c) a N,N′bis(dialkyl)-1,4,5,8-naphthalenetetracarboxylic diimide derivative represented by: 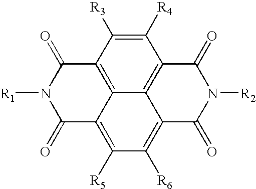
wherein R1 is substituted or unsubstituted alkyl, branched alkyl, cycloalkyl, alkoxy or aryl such as phenyl, naphthyl, or a higher polycyclic aromatic such as anthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have a total carbon number of between 1 and 50, and wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, wherein R3, R4, R5 and R6 can be the same or different;
d) a N,N′bis(diaryl)-1,4,5,8-naphthalenetetracarboxylic diimide derivative represented by: 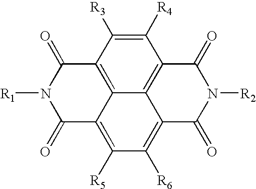
wherein R1 is substituted or unsubstituted alkyl, branched alkyl, cycloalkyl, alkoxy or aryl such as phenyl, naphthyl, or a higher polycyclic aromatic such asanthracene, wherein R2 is substituted or unsubstituted alkyl, branched alkyl, cycloalkyl, alkoxy or aryl such as phenyl, naphthyl, or a higher polycyclic aromatic such as anthracene, wherein R1 and R2 can be chosen independently to have total carbon number between 1 and 50, wherein R3, R4, R5 and R6 are selected from the group consisting of alkyl, branched alkyl, cycloalkyl, alkoxy or aryl such as phenyl, naphthyl, or a higher polycyclic aromatic such as anthracene, and halogen, and wherein R3, R4, R5 and R6 can be the same or different;
e) a 1,1′-dioxo-2-(aryl)-6-phenyl-4-(dicyanomethylidene)thiopyran derivative represented by: 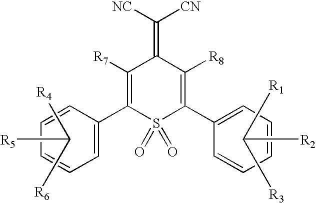
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
f) a carboxybenzylnaphthaquinone derivative represented by: 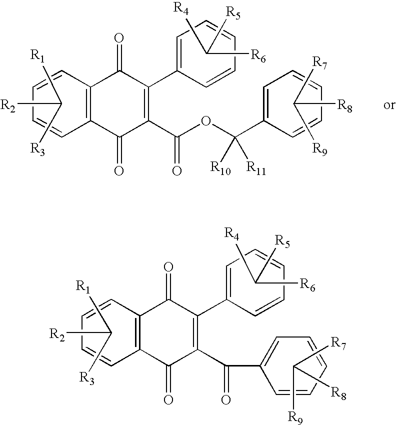
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
g) a diphenoquinone represented by: 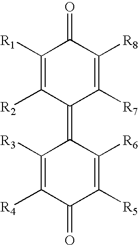
wherein each R is independently selected from the group consisting of hydrogen, alkyl having 1 to 40 carbon atoms, alkoxy having 1 to 40 carbon atoms, phenyl, substituted phenyl, higher aromatic such as naphthalene and antracene, alkylphenyl having 6 to 40 carbons, alkoxyphenyl having 6 to 40 carbons, aryl having 6 to 30 carbons, substituted aryl having 6 to 30 carbons and halogen;
h) and mixtures thereof.

9. The process of claim 8, wherein the first coating is dried after being applied so as to form an undercoat layer and wherein the second coating is dried after being applied so as to form a charge transport layer.

10. The process of claim 8, wherein the metal oxide is selected from the group consisting of ZnO, SnO₂, Al₂O₃, SiO₂, ZrO₂, In₂O₃, MoO₃, and mixtures thereof.

11. The process of claim 8, wherein the metal oxide is TiO₂.

12. The process of claim 8, wherein the thickness of the undercoat layer is from about 0.2 microns to about 30 microns.

13. The process of claim 8, wherein the metal oxide is present in an amount of from about 5 percent to about 90 percent by weight of the total weight of the undercoat layer.

14. The process of claim 8, wherein the electron transport additive is present in an amount of from about 0.05 percent to about 10 percent by weight of the total weight of the charge transport layer.

15. The process of claim 8, wherein the amount of metal oxide in the first coating and the amount of electron transport additive in the second coating are sufficient to reduce ghosting in image reproduction.

16. The process of claim 8, wherein the coating is formed by doping the electron transport additive into a dispersion of a charge transport layer formulation.

17. The process of claim 8, wherein the coating is formed by dispersing the electron transport additive with the charge transport layer formulation.
